(19) United States
(12) Patent Application Publication
(10) Pub. No.: US 2017/0039797 A1
(43) Pub. Date: Feb. 9, 2017

(54) Smoothie Delivery Vending System

(71) Applicant: Ramy Elmery, Woodbridge, VA (US)

(72) Inventor: Ramy Elmery, Woodbridge, VA (US)

(21) Appl. No.: 14/816,777

(22) Filed: Aug. 3, 2015

(51) Int. Cl. G07F 17/00; A23G 9/08; A23G 9/30; A23G 9/42; G07F 13/10; G06Q 20/24; G07F 9/10; G07F 13/06; G06Q 20/18; G06Q 20/20; G06Q 20/26; A23G 9/04; G07F 7/08

(52) U.S. Cl. CPC G07F 17/0071; A23G 9/045; A23G 9/08; A23G 9/30; A23G 9/42; G07F 13/10; G07F 7/08; G07F 9/105; G07F 13/065; G06Q 20/18; G06Q 20/204; G06Q 20/26; G06Q 20/24; A23V 2002/00

(57) ABSTRACT

The invention relates to a smoothie delivery vending machine that provides the consumer with the option of choosing ingredients of their choice, using a computer touchscreen that is connected to a computing system. The ingredients chosen are delivered using a frozen food delivery system. The ingredients are blended using a blender of blending system and dispensed through solenoid valves inside a disposable cup, which is dispended by a cup-dispenser unit. The ingredients are mixed inside the disposable cup using a sanitary mixer. The consumer has the option of payment for the drink in cash, by debit card and/or credit card.

### CROSS REFERENCE TO RELATED APPLICATIONS

Not applicable

### FEDERALLY SPONSORED RESEARCH AND DEVELOPMENT

Not applicable.

### MICROFICHE

Not applicable)

### BACKGROUND OF THE INVENTION

(1) Field of the Invention

The present disclosure relates generally to an integrated method and system for dispensing and blending/mixing beverage flavor/ingredients, thereby producing a beverage, e.g., a smoothie. More particularly, the present disclosure relates to a system and method for creating and delivering healthy customized drinks.

(2) Background of the Invention

A fast-paced world is faced by everyone today and with this convenience & quality of the beverages consumed have become increasingly important. Beverage consumption is an important part of daily living and one must consume adequate quantities of proper liquids every day in order to maintain health, fitness, and quality of life. Additionally, the ever-expanding number of beverage choices continues unabated as develop and introduce new beverages by the score every year.

With the growth of more beverage choices, custom made drinks have blossomed into big business and the consumer is spoiled for a beverage of their choice with ingredients of their choice. Some of the popular retail beverage locations will provide a beverage consumer with the option of selecting a “base” liquid (e.g., milk, fruit juice, vegetable juice, etc.) and then water or ice may be added to achieve the desired consistency and volume for the beverage. Many locations will provide the consumer with the option to add in fruit or vegetables and other types of ingredients. Some of them include vitamins, minerals, fiber, and herbs that are believed to provide the beverage consumer with the desired balance of ingredients for a delicious and healthy beverage >Eventually, all of these ingredients are placed into a mixer or blender, blended together, and then delivered to the beverage consumer for consumption.

U.S. Pat No. 8,534,501, discloses an assembly for dispensing and mixing a beverage that includes an ice dispenser assembly, a flavor/ingredient dispensing module, and a blender/mixer/cleaning module as one integrated assembly and a controller that provides integrated control between menu selection, portioning of ice and dispensing of the ingredient(s) based upon the menu selection performed by the customer, and blending and/or mixing based upon the menu selection. The controller also activates the cleaning mode.

U.S. Pat. App. No. 2012020285986, discloses a system for the automated preparation and delivery of customized beverages. The system is deployed as a kiosk or similar device and provides an automated user-customizable drink purchasing experience. The user can select the desired base, add-in ingredients, etc. and receive a drink that has been prepared in accordance with the user preferences.

U.S. Pat. No. 8,685,477, discloses a method and apparatus for preparing a single serving of a frozen slurry beverage in a disposable drink container or cup. The method of the present invention comprises the steps of creating substantially uniform frozen slurry beverage of a predetermined consistency; and removing the disposable drink container or cup with the substantially uniform frozen slurry beverage from the beverage blending station of the beverage blending device.

Accordingly, without additional improvements in the current systems, products, and methods for creating and delivering customized drinks such as smoothies, the overall process and user experience will continue to be sub-optimal.

Thus, there is a long-felt need to provide a beverage delivery vending system that provides touchscreen for users to customize the ingredients; creates beverage inside drink container or cup; and comes with replaceable cartridges of frozen fruits, proteins, kale etc, for delivering a beverage that satisfies customers on the move, who want a beverage of their selected ingredients and, at the same time that is cost effective. Therefore, in this way this invention provides a smoothie delivery vending system which has all advantages of previous arts but overcomes their disadvantages.

### SUMMARY OF THE INVENTION

In the view of the foregoing disadvantages inherent in the known types of beverage delivery vending systems now present in the prior art, the present invention provides an improved beverage delivery vending system. As such, the general purpose of the present invention, which will be described subsequently in greater detail, is to provide a new and improved smoothie vending machine which has all the advantages of the prior art and none of the disadvantages.

An object of the invention is to provide a smoothie delivery vending system for delivering healthy beverage for customers on the move.

It is another object of the present invention to provide a smoothie delivery vending system with touchscreen for delivering healthy smoothie with customized ingredients.

It is another object of the present invention to provide a smoothie delivery vending system with for delivering customized smoothie with a clean dispensing system in place.

It is another object of the present invention to provide a system and method that help create smoothie inside a disposable cup with customized ingredients using a sanitary mixer.

It is another object of the present invention to provide substantially uniform smoothie of a predetermined consistency.

It is another object of the present invention to create a smoothie or other frozen drink in 20 seconds or less,

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure, For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows open smoothie delivery vending system.

FIG. 2 shows closed smoothie delivery vending system.

FIG. 3 shows preferred embodiment of the smoothie delivery vending system.

FIG. 4 shows credit card processing unit of the smoothie delivery system.

FIG. 5 shows storage cubes for fruits and vegetables.

FIG. 6 shows the refrigerator elements for fruits and vegetables, blender and heating element.

FIG. 7 shows the rear view of smoothie vending system.

FIG. 8 shows the side view of smoothie delivery vending system with blender.

FIG. 9 shows the front view of smoothie delivery vending system with blender.

### DETAILED DESCRIPTION OF THE INVENTION

In the following detailed description, reference is made to the accompanying drawings which form a part hereof, and in which is shown by way of illustration specific embodiments in which the invention may be practiced, These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

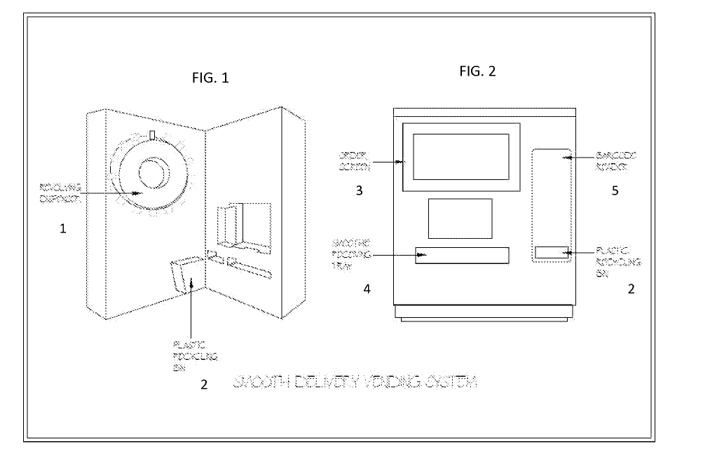

On referring FIG. 1 shows a Smoothie delivery vending machine for delivering smoothies with ingredients of consumer's choice. The figure shows a revolving dispenser (1) and a plastic recycling bin (2). The revolving dispenser dispenses different ingredients as per choice of the consumer.

FIG. 2 shows an order screen (3) which facilitates a user to place an order with ingredients of their choice. The screen is a touch sensitive screen that provides enhanced user experience, Further the figure shows a smoothie receiving tray (4), a barcode reader and a plastic recycling bin (2).

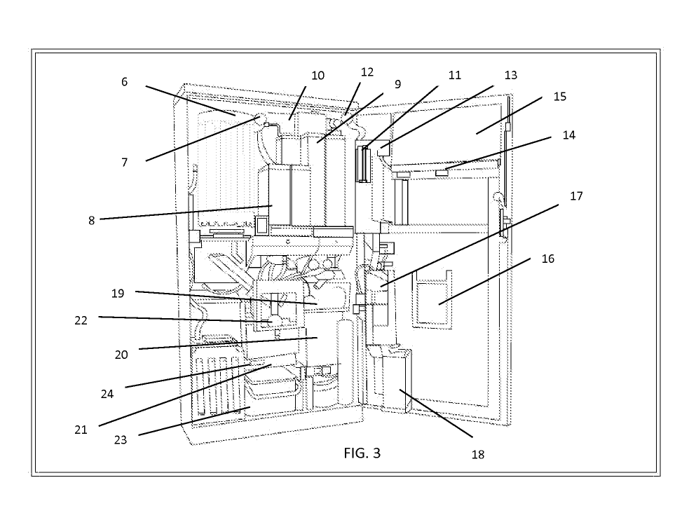

FIG. 3 shows the front view of a smoothie delivery vending machine that is open and gives customized smoothie or my own smoothie, The figure shows various parts of the machine that includes a cup dispenser unit (6) for dispensing cup/s in which the blending of ingredients will take place, a water reservoir (7) for supplying water, ingredient containers (8) & (9) for storing different ingredients, a water filter (10), a beverage-selector mechanism reservoir (10), a drinks preset counter (12), a cold-drink counter (13), display-sign light chokes (14), display-sign lights hinged mounting (15), a clear-view vend door (16), Coin-selector mechanism (17), a coin box (18),a cooler unit water filler plug (19), a cooler unit (20), a hot-water thank thermostat (21), a grill (22), a waste bucket (23) and a waste bucket overflow cut-off switch (24). that dispenses disposable cups, a water reservoir tank (2) that stores and also provides water for making beverages, Ingredient containers (3) & (4) for storing as well as providing ingredients, a water filter (5) that provides clean water, a beverage selector mechanism (6) for providing customer with beverage option that has been selected. The coin-selector mechanism (17) is for dispensing change to customer in case of cash payment and the coin box (18) for collecting coins.

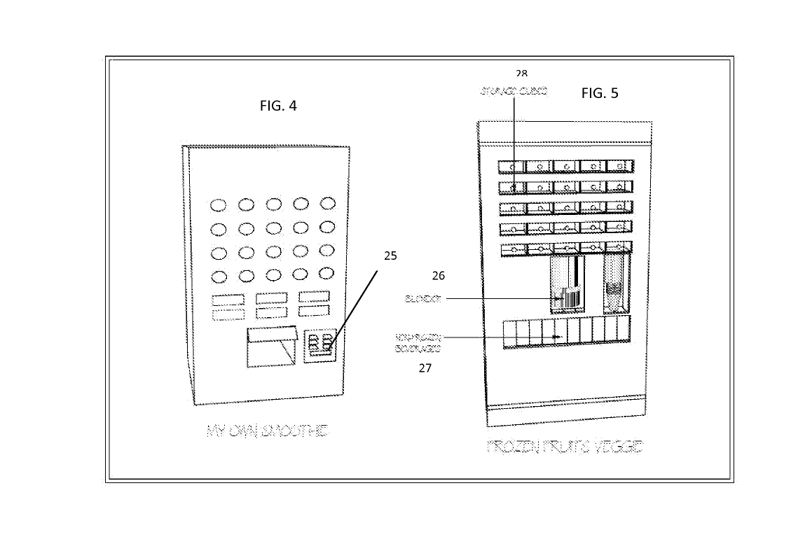

FIG. 4 shows smoothie vending machine with a credit card processor unit (25). The vending machine takes both debit and credit cards as mode for receiving payment for the beverage ordered by the consumer. FIG. 5 shows storage cubes (28) in which ingredients such as frozen fruits and vegetables are stored. The figure also shows non frozen beverages (27). The machine provides for a blending system that consists of a blender (26) for blending the ingredients for making a beverage (smoothie) of customer's choice. The blending system further provides for water and/or cleaning and/or sanitizing solution supply system connected to a container holder for cleaning and/or sanitizing,. Once the order of customer is completed and he/she has their drink, the blender pot is flushed with water and/or sanitizing solution to prevent transfer of flavors or germs. The figure also shows non frozen beverage mixer. The mixer used here is a clamp mount ½ HP gear drive electric stainless steel sanitary mixer which are excellent for pharmaceutical, food, cosmetic or dairy application where OP or wash-down capability is required. This economy model includes a white epoxy wash-down finish in addition to the 316 stainless steel shaft and impellers and can be exposed to high pressure cleaning and detergents. An air solenoid connected to water line can be energized to provide a high-pressure blast of water during the mixer cleaning cycle as well as providing an air blast to assist in removing residual water from the blender module.

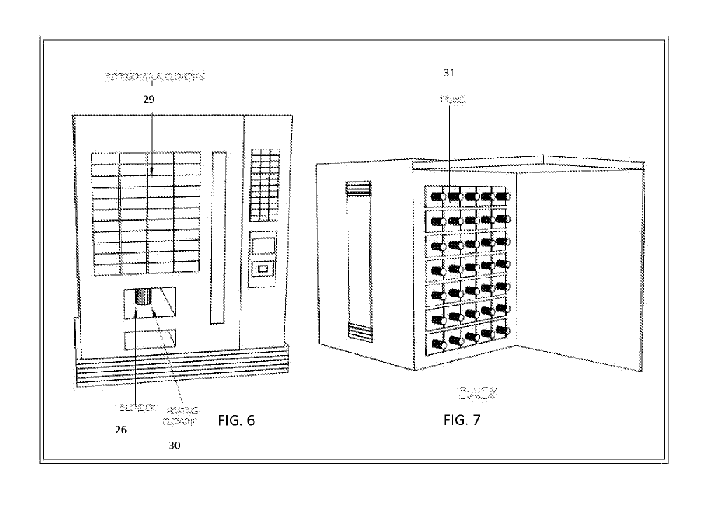

FIG. 6 shows the smoothie delivery vending machine with front gate closed. The refrigerator elements (29) form part of refrigerated food delivery system that provides cold water and milk. The blender (26) has blades that blend the various elements which consist of a smoothie. The freezer elements keep the fruits and vegetables frozen such that they can be used while making different smoothies. The dispensing system includes an electromechanically operated valve's known as solenoid valve for dispensing various ingredients into a disposable cup.

Inside the enclosure of the machine are fruit flavors and milk cartridges. These cartridges revolve to provide a flavor according to choice of the customer. The figure also shows heating element (30).

FIG. 7 shows the rear view of closed smoothie delivery vending machine. The rear portion of the machine has trays (31) that used to store raw fruits and vegetables.

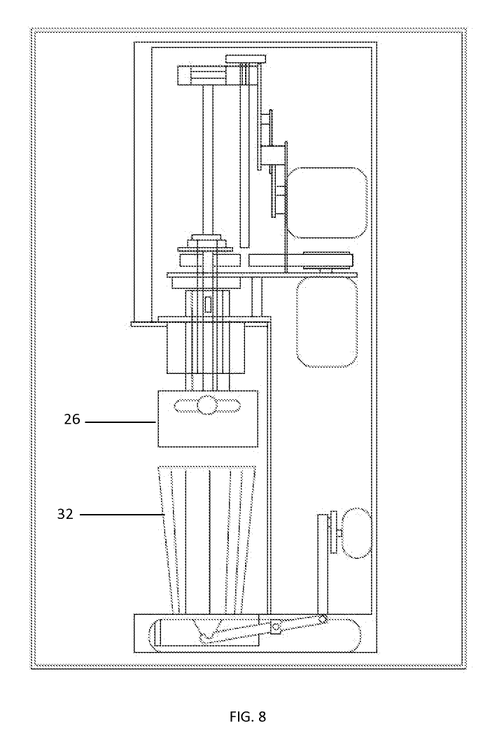

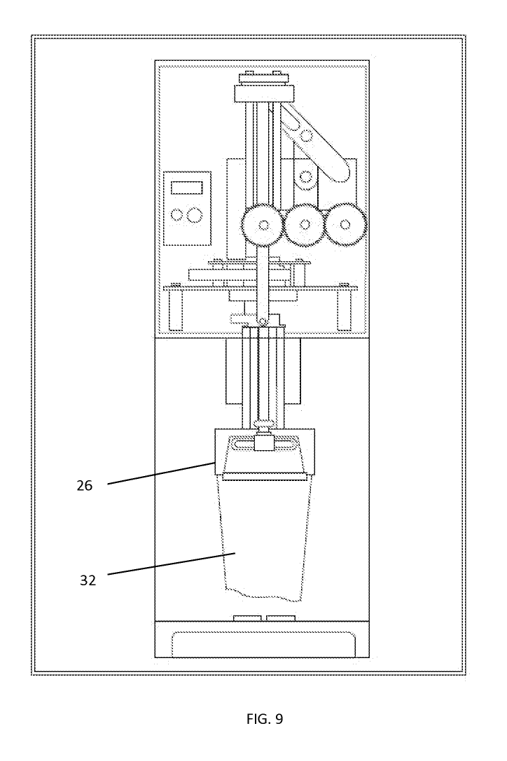

FIG. 8 refers to side view of the proposed smoothie delivery vending machine. The figure shows the blender (26) at its starting point and a disposable cup (32). FIG. 9 refers to front view of the machine where the blender (26) is shown partially inside the disposable cup (32). The blending of the ingredients takes place inside the cup and hence provides a sanitary system for delivery of smoothie.

Advantageously, the present invention is different from the existing knowledge. Like, prior beverage vending machines provide for only those flavors whose fruits are available in local market. But with this smoothie delivery vending machine, the customer can have a beverage that includes ingredients such a frozen fruits and vegetables of their choice that can be selected using a touchscreen surface. It also provides beverage whose ingredients are blended and mixed inside a disposable cup and delivered in 20 seconds of placing order, thereby avoiding mixing of different flavors and germs. Thus, this machine gives the customer on the move a perfect opportunity to have a smoothie made from ingredients of their choice and at much faster rate as compared to machines in past.

The present invention is not limited for the beverages preparation, The system can also be used for mixing of other beverages such as coffee, alcohol, milkshakes etc.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed:

1. A delivery system for a blended drink, comprising:
a cabinet having a refrigerator compartment and a freezer compartment;
a computer touch-screen operative connected to a computing system locating inside said cabinet;
a frozen food delivery system located in said freezer compartment;
a refrigerated food delivery system located in said refrigerator compartment;
a blending device located in said cabinet;
a cup dispensary system; and
a payment device, connected to said computing system, allowing a user to pay for a blended drink.

2. The delivery system for a blended drink, according to claim 1, wherein said refrigerated food delivery system provides cool water and milk to be added for making a customized drink.

3. The delivery system for a blended drink, according to claim 1, wherein said blending device located in said cabinet is flushed with a sanitized solution or water to prevent the transfer of flavors and germs.

4. The delivery system for a blended drink, according to claim 1, wherein said cup dispensary system dispenses a disposable cup.

5. The delivery system for a blended drink, according to claim 1, wherein said payment device, connected to said computing system, allowing the user to pay for the blended drink by receiving cash, accepting a debit card and a credit card.

6. The delivery system for a blended drink, according to claim 1, wherein the system is electrically powered.

7. The delivery system for a blended drink, according to claim 1, wherein said computer touch screen allowing a user to select from a variety of ingredients.

8. The delivery system for a blended drink, according to claim 1, wherein said frozen food delivery system allowing for a portion of frozen food to be delivered to said blending device when said user selects frozen food option.

9. The delivery system for a blended drink, according to claim 1, wherein said frozen food delivery system having a set of storage containers.

10. The delivery system for a blended drink, according to claim 9, wherein said storage containers are uniform and interchangeable with each other.

11. The method for delivery of a blended drink, comprising steps of:
providing a cabinet, said cabinet including a freezing compartment and a refrigerator compartment;
customizing ingredients to be included in a said blended drink as per a consumer, using a computer touchscreen operative connected a computing system locating inside said cabinet;
freezing fruits and vegetables stored in freezing compartment;
refrigerating water and milk stored in refrigerator compartment;
providing a payment device connected to said computing system, for allowing said consume to pay for said blended drink;
sanitizing a blending device located in said cabinet using a sanitizing solution or water to prevent transfer of flavors and germs;
dispensing a disposable cup for delivering said blended drink;
mixing ingredients inside said disposable cup using a sanitary mixer;
delivering said blended drink containing pre-selected and mixed ingredients in said disposable cup.

12. The method for delivery of a blended drink, according to claim 11, wherein said payment device connected to said computing system is designed to receive cash, debit card and credit card.

13. The method for delivery of a blended drink, according to claim 11, wherein said freezing compartment consists of trays in which fruits and vegetables are stored.

14. The method for delivery of a blended drink, according to claim 11, wherein said cabinet equipped with a water filter.

15. The method for delivery of a blended drink, according to claim 11, wherein said cabinet equipped with a water reservoir.

16. The method for delivery of a blended drink, according to claim 11, wherein said blended drink is chosen using a beverage-selector mechanism.

17. The method for delivery of a blended drink, according to claim 11, wherein consumer is charged according to ingredients chosen to be included in said blended drink.
